(19) United States
(12) Patent Application Publication
(10) Pub. No.: US 2025/0103950 A1
(43) Pub. Date: Mar. 27, 2025

(54) TIME-SERIES FORECASTING AND MACHINE-LEARNING MODEL PARAMETER OPTIMIZATION

(71) Applicant: International Business Machines Corporation, Armonk, NY (US)

(72) Inventors: Christopher William Watson, Wildberg (DE); Andrés García Saravia Ortiz de Montellano, Böblingen (DE); Dieter Wellerdiek, Ammerbuch (DE); Jakob Christopher Lang, Walddorfhäslach (DE); Giao Nguyen-Quynh, Ehningen (DE)

(21) Appl. No.: 18/494,141

(22) Filed: Oct. 25, 2023

(30) Foreign Application Priority Data
Sep. 25, 2023 (GB) 2314621.0

(51) Int. Cl. G06N 20/00

(52) U.S. Cl. CPC G06N 20/00

(57) ABSTRACT

A method for time-series forecasting for time-series data with a periodic behavior larger than a respective sampling rate is disclosed. The method includes selecting candidate time lag values from measured time-series data, determining first training data based on time-series data and the candidate time lag values, and training of a first machine-learning system, thereby determining a subset of the set of the first training data. The method further includes building second training data, training of a second machine-learning system for time-series predictions when using measured sampled time-series data as input. A first performance indicator value is indicative of a prediction performance of the first time-series machine-learning model. The method further includes determining that an element of the set of second training data is significant for the training of the first time-series machine-learning model and determining that the set of second training data is complete.

### BACKGROUND

Aspects of the invention relate generally to a computer-implemented method for time-series forecasting, and more specifically, to a computer-implemented method for time-series forecasting for time-series data with a periodic behavior larger than a respective sampling rate. The invention relates further to a related time-series data forecasting system for time-series forecasting for time-series data, and a related computer program product.

When measuring real-time data, it is often time-series data. This applies to IoT (Internet of Things) data but also to a variety of other application areas, such as warehouse management, logistic applications, proactive maintenance applications, as well as, forecasting stock-price development, among others. Hence, measured values may be sampled over time in order to predict future trends in order to gain competitive advantage. Often, the variation in time of the predicted value can depend on different influencing factors; hence, accurate, time-dependent forecasts are typically complex. Various approaches have been made to solve this complex task.

As an example, document US 2022/0292308 A1 describes systems and methods for time-series modeling. Whereby, a system identifies a first data set that includes a plurality of time-series having a plurality of characteristics. A first time series may differ from a second time series. The system selects, based at least in part on the plurality of characteristics of the time-series, a plurality of models. Then, a machine-learning model is trained. In another document, namely US 2023/0237386 A1, forecasting time-series data using ensemble learning is described. Also here, the focus is on predicting the future value of a time-series. Here, the proposed method includes generating a feature vector. The feature vector comprises a set of raw features and a plurality of lag features, where the plurality of lag features includes a current value of a selected feature in the set of raw features and one or more historical values of the selected feature. The feature vector is then input to a plurality of base models which are producing a plurality of predictions.

However, known models still have their limitations. Some approaches may require a manual analysis in order to observe seasonality in the data, other approaches use all measured data making a prediction model development very time-consuming and complex. Again other approaches are not applicable for very long data sets. Hence, existing models for time-series forecasting have to make compromises between the complexity of developing the model and the sampled data that can be considered.

Therefore, there may be a need to overcome these limitations in order to find a good balance between a model simplicity and accuracy of the model. Additionally, the used approach should be scalable and adaptable.

### SUMMARY

According to one aspect of the present invention, a computer-implemented method for time-series forecasting for time-series data with a periodic behavior larger than a respective sampling rate may be provided. The method may comprise providing measured sampled time-series data, selecting a set of candidate time lag values, and determining a set of first training data based on the measured sampling time-series data and the candidate time lag values.

Additionally, the method comprises training of a first machine-learning system for building a regularized machine-learning model, using the set of first training data and respective measured sampling time-series data as target data. Thereby, determining a subset of the set of the first training data may be determined. The subset may be related to a set of most influential time lag values when training the regularized machine-learning model, wherein the set of most influential time lag values comprises a set of long-term lag values and a set of short-term lag values.

Moreover, the method may comprise building a set of second training data based on the long-term lag values and related measured sampling time-series data and training of a second machine-learning system for building a first time-series machine-learning model for time-series predictions when using measured sampled time-series data as input, wherein the training is using as input: (i) the set of second training data, related measured sampled time-series data and (ii) the set of short-term lag values. Thereby, a first performance indicator value may be indicative of a prediction performance of the first time-series machine-learning model.

Furthermore, the method may comprise determining that an element of the set of second training data is significant for the training of the first time-series machine-learning model, and determining, after the determining that an element of the second training data is significant, that the set of second training data is complete.

According to another aspect of the present invention, a time-series data forecasting system for time-series forecasting for time-series data with a periodic behavior larger than a respective sampling rate may be provided. The system may comprise one or more processors and a memory operatively coupled to the one or more processors, wherein the memory stores program code portions that, when executed by the one or more processors, enable one or more processors to provide measured sampled time-series data, to select a set of candidate time lag values, to determine a set of first training data based on the measured sampling time-series data and the candidate time lag values, and to train of a first machine-learning system for building a regularized machine-learning model, using the set of first training data and respective measured sampling time-series data as target data. Thereby, a subset of the set of the first training data may be determined, and the subset may relate to a set of most influential time lag values when training the regularized machine-learning. And, the set of most influential time lag values may comprise a set of long-term lag values and a set of short-term lag values.

During the second feature creation one or more processors may further be enabled to build a set of second training data based on the long-term lag values and related measured sampling time-series data, to train of a second machine-learning system for building a first time-series machine-learning model for time-series predictions if using measured sampled time-series data as input. Thereby, the training may use as input: (i) the set of second training data, related measured sampled time-series data and (ii) the set of short-term lag values. And, a first performance indicator value may be indicative of a prediction performance of the first time-series machine-learning model.

Last but not least the one or more processors may be enabled to determine that an element of the set of second training data is significant for the training of the first time-series machine-learning model, and determine, after the determining that an element of the second training data is significant, that the set of second training data is complete.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating or transporting the program for use by or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered to be disclosed within this document.

The aspects defined above and further aspects of the present invention are apparent from the examples of embodiments to be described hereinafter and are explained with reference to the examples of embodiments to which the invention is not limited.

Preferred embodiments of the invention will be described, by way of example only, and with reference to the following drawings:

FIG. 1 shows a block diagram of an embodiment of the inventive computer-implemented method for time-series forecasting for time-series data with a periodic behavior larger than a respective sampling rate.

FIG. 2 shows a diagram of exemplary time-series data.

FIG. 3 shows a first part of a block diagram of a more implementation-near embodiment of the proposed concept.

FIG. 4 shows a second part of the block diagram of the more implementation-near embodiment of FIG. 3.

FIG. 5 shows a block diagram of the applied backward training of the proposed concept.

FIG. 6 shows a block diagram of the applied forward training of the proposed concept.

FIG. 7 shows an illustration of a Fourier transformation as used in an embodiment of the proposed concept.

FIG. 8 shows a block diagram of an embodiment of the inventive time-series data forecasting system for time-series forecasting for time-series data with a periodic behavior larger than a respective sampling rate.

FIG. 9 shows an embodiment of a computing system that can comprise the system according to FIG. 8.

### DETAILED DESCRIPTION

Embodiments of the inventive concept can be described as follows:
(1) According to one aspect of the present invention, a computer-implemented method for time-series forecasting for time-series data with a periodic behavior larger than a respective sampling rate may be provided. The method may comprise providing measured sampled time-series data, selecting a set of candidate time lag values, and determining a set of first training data based on the measured sampling time-series data and the candidate time lag values.

Additionally, the method comprises training of a first machine-learning system for building a regularized machine-learning model, using the set of first training data and respective measured sampling time-series data as target data. Thereby, determining a subset of the set of the first training data may be determined. The subset may be related to a set of most influential time lag values when training the regularized machine-learning model, wherein the set of most influential time lag values comprises a set of long-term lag values and a set of short-term lag values.

Moreover, the method may comprise building a set of second training data based on the long-term lag values and related measured sampling time-series data and training of a second machine-learning system for building a first time-series machine-learning model for time-series predictions when using measured sampled time-series data as input, wherein the training is using as input: (i) the set of second training data, related measured sampled time-series data and (ii) the set of short-term lag values. Thereby, a first performance indicator value may be indicative of a prediction performance of the first time-series machine-learning model.

Furthermore, the method may comprise determining that an element of the set of second training data is significant for the training of the first time-series machine-learning model, and determining, after the determining that an element of the second training data is significant, that the set of second training data is complete.

According to another aspect of the present invention, a time-series data forecasting system for time-series forecasting for time-series data with a periodic behavior larger than a respective sampling rate may be provided. The system may comprise one or more processors and a memory operatively coupled to the one or more processors, wherein the memory stores program code portions which, when executed by the one or more processors, enable one or more processors to provide measured sampled time-series data, select a set of candidate time lag values, determine a set of first training data based on the measured sampling time-series data and the candidate time lag values, and train of a first machine-learning system for building a regularized machine-learning model, using the set of first training data and respective measured sampling time-series data as target data. Thereby, a subset of the set of the first training data may be determined, and the subset may relate to a set of most influential time lag values when training the regularized machine-learning. Thereby, the set of most influential time lag values may comprise a set of long-term lag values and a set of short-term lag values.

The one or more processors may further be enabled to build a set of second training data based on the long-term lag values and related measured sampling time-series data, train of a second machine-learning system for building a first time-series machine-learning model for time-series predictions when using measured sampled time-series data as input. Thereby, the training may use as input: (i) the set of second training data, related measured sampled time-series data and (ii) the set of short-term lag values. Thereby, a first performance indicator value may be indicative of a prediction performance of the first time-series machine-learning model.

Last but not least, the one or more processors may be enabled to determine that an element of the set of second training data is significant for the training of the first time-series machine-learning model, and determine, after the determining that an element of the second training data is significant, that the set of second training data is complete.

The proposed computer-implemented method for time-series forecasting for time-series data with a periodic behavior larger than a respective sampling rate may offer multiple advantages, technical effects, contributions and/or improvements:

Firstly, using the regularized regression algorithm for the first machine-learning (ML) system/ML model, a good balance between the model simplicity and the model accuracy may be achieved. This can be achieved by adding a penalty term to the traditional linear regression model, which may encourage sparse solutions, where some coefficients may be forced to be exactly ZERO. This feature may render the, e.g., LASSO (i.e., Least Absolute Shrinkage and Selection Operator) model particularly useful for feature vector selection because it may automatically identify and discard irrelevant or redundant variables, i.e., training data for a subsequent ML system/ML model.

This achieves the goal, the objective of the proposed concept, namely finding a good balance between the simplicity of the model and the accuracy of the model, even for a large number of input data. Even better, manual analysis of seasonality effects within the sampled data may not be required. Furthermore, also multi-seasonality effects may be addressed by the proposed approach. Also, in contrast to traditional solutions, the usage of non-equidistant lags helps to reduce the amount of training data to make optimization loop routines for the ML model for forecasting the time-series data efficient and feasible.

The proposed concept goes clearly beyond the usage of sampled time-series data of one fixed time-period. The usage of the entire set of sampled time-series data during the first time period, the usage of time-series data points during or at the ends of the second time period, and the optional usage during or at the end of a third time period makes the concept proposed here successful as it is possible to work with a reduced amount of data and at the same time use a much larger data space. Furthermore, also the usage of data points in a surrounding of the data points of the second time periods (the same may apply to the third time periods) makes the concept proposed here especially efficient.

Furthermore, the proposed concept is superior to approaches like PACF (partial autocorrelation function) as they are not applicable to large data sets such as those used here. Additionally, the optional use of the LASSO model for the first machine learning system helps to reduce the required data points further.

And by using optimization, and, in particular, forward optimization, it may be ensured that only significant data points are used for the original time-series data, and may identify additional data points that may support an even better model. As a result of the double optimization of the ML model for time-series forecasting/prediction a very efficient ML model can be presented. This may allow a prediction of computer system's workload for the next, e.g., two minutes based on just a few of sampled data points in a few of seconds. With this, the underlying computer system may be controlled in a way to closely approach its theoretical maximum of workloads.

Furthermore, a usage of comparably costly SVR (support vector regression) is not required; instead, the simpler but very effective LASSO algorithm and a Fourier transformation may be used.

In additions, this process may reduce the quantity of data that is required by the final model at inferencing time, and therefore it may also reduce the required processing resources when the final model is used after this process.

In the following, additional embodiments of the inventive concept—applicable for the method as well as for the system—will be described.

According to an interesting embodiment of the method, the selecting the candidate time lag values may comprise selecting candidate time lag values from a first time period, and selecting candidate time lag values at a plurality of second time periods and their time surroundings. As an example, in one application area it has been proven to be advantageous to choose a duration of about one hour for the first time period. In a simpler version, the wording “a plurality of second time periods” may be interpreted as selecting candidate time lag values at the end of the second hour, the third hour, and so on. However, the second time period does not need to be a natural plurality of the first time period. As an example, the second time period length can also just be 20 minutes, 45 minutes, 1½ hour, two hours or, any other regular time interval.

Furthermore, additional candidate time lag values may be selected at a plurality of a third time period—at an end of it—which may be longer than the second time period, e.g., daily or at the end of the day. Furthermore, additional candidate time lag values may also be selected around the point in time of selecting the additional time lag values at the third time period. “In the surrounding” may describe here, that “a couple” of additional candidate time lag values before and after may also be selected. “A couple” may typically describe two or three additional candidate time lag values before and after the sampled measured data at the third time periods. Typically, the same number of additional candidate time lag values before and after may be identical. However, they may have also different numbers.

A pure numerical example (without time units) shall be used to illustrate how data can be selected:
block 1 for the 1^{st} time period: 1, 2, 3, . . . 999, 1000, 1001, 1002;
block 2 for the second time period(s): 1498, 1499, 1501, 1502; 1998, 1999, 2000, 2001, 2003; 2498, 2499, 3000, 3001, 3002, . . . 9998, 9999, 10000, 10001, 10002; i.e., 5 data points per 500units;
block 3 for the third time period: 19998, 19999, 20000, 20001, 20002; 29998, 29999, 30000, 30001, 30002; 39998, 39999, 40000, 40001, 40002; 99998, 99999, 100000, 100001, 100002; i.e., 5 data points every 10000 units.
   Here, it is understandable here that there are 2 data points in the surrounding before the reference time period and 2 data points after the reference time period. In reality, using the workload management example, most likely final values can be one or more of 5 min., 10 min., 15 min., 20 min., 30 min., 1 h, 2 h, 3 h, 6 h, 12 h, 1 day, 1 week.

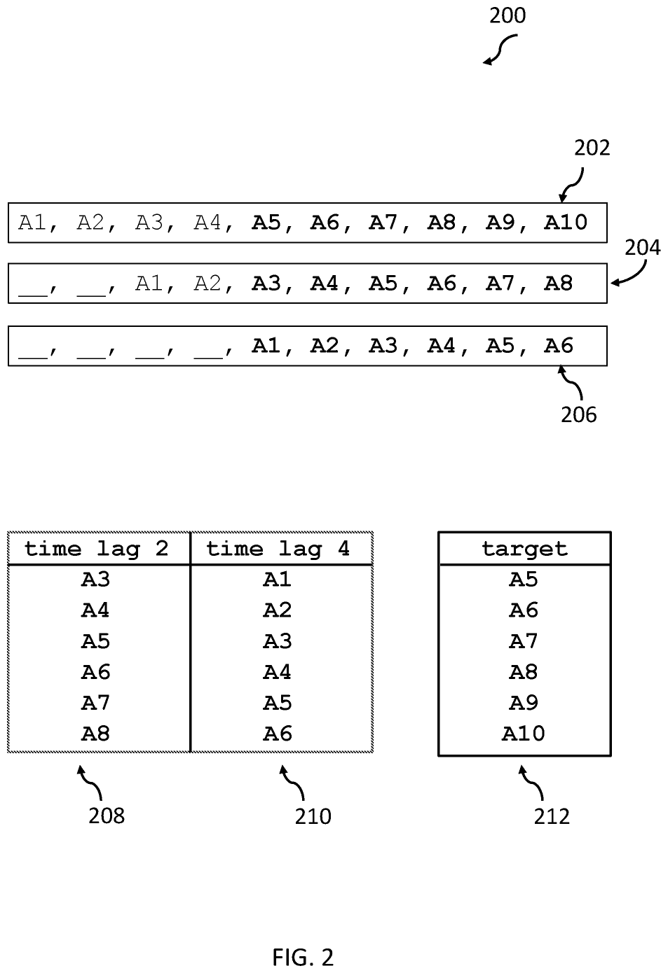

According to an advantageous embodiment of the method, the determining the set of first training data may comprise building a table-in particular, comprising columns or rows as primary organization criteria, where components of table dimensions comprise elements of the measured sampled time-series data respectively shifted by selected candidate time lag values. The shifting may be executed according to a predefined schema. One example will be described later in the context of FIG. 2.

According to a useful embodiment of the method, the regularized machine-learning model may be selected out of the group consisting of a Least Absolute Shrinkage and Selection Operator regression algorithm (LASSO or L1 regulation), a Ridge regression algorithm (L2 regulation), an elastic net regression algorithm, and a tree-based machine-learning model. Other regression algorithms or machine-learning models may be applied. In general, the LI regulation has proven to be a solid basis for, e.g., IT system workload management applications, where data are sampled, e.g., every 10 seconds.

The named regression models stand here for LASSO regression, i.e., Least Absolute Shrinkage and Selection Operator, which is also known as L1 regularization. It is a well understood technique used in statistical modeling and machine learning to estimate relationships between variables and to make predictions. The primary goal of LASSO regression in finding a good balance between model simplicity and accuracy. This is achieved by adding a penalty term to the traditional linear regression model, which encourages sparse solutions where some coefficients are forced to be exactly zero.

According to an enhanced embodiment of the method, the determining that an element of the second training data is significant for the training of the first time-series machine-learning model may comprise deselecting an element of the second training if its exclusion results in a smaller or equal second performance indicator value if compared to the first performance indicator value. Thereby, the second performance indicator value may be indicative of a prediction performance of the second time-series machine-learning model, and the second time-series machine-learning model may be trained in the same way as the first time-series machine-learning model but without the deselected element of the second training data. Additionally, this approach may be repeated for all elements of the second training data. This concept may be denoted as “backward optimization” because it may ensure that an important time lag values in the sampled data may be removed in order to reduce the amount of data in order to increase the performance of the inventive concept.

In addition to the just described enhanced embodiment, another enhanced embodiment of the method may comprise that the determining that the set of second training data is complete may comprise performing a Fourier transformation of an error signal, wherein the error signal is a difference signal between ground truth time-series data and predicted time-series data of the first time-series machine-learning model. This approach, as part of the inventive concept may ensure that additional time lag values are considered and potentially added to the training data in order to not overlook important lag values relevant for the training of the machine-learning model.

According to a further developed embodiment, the method may also comprise adding candidate time lags surrounding a frequency of a peak value in an amplitude of the Fourier transformation. Thereby, the frequencies determined as a result of the Fourier transformation may be interpreted as time lag values. The “surrounding” may be a predefined interval or may be determined using a threshold technique, optionally depending on a current frequency. The so determined additional time lag values may be added to the second training data and used as additional training data for the training of the second machine-learning model.

According to another advanced and advantageous embodiment of the method, the peak frequency value may instead be a plurality of peak frequency values of the Fourier transformation. This schema may then be directly mirrored to the time lag values, as just described in the previous paragraph.

According to a preferred embodiment of the method, the first performance indicator, the second performance indicator and the third performance indicator may be selected out of the group consisting of a mean squared error, a root mean squared error, an Akaike information criterion value, a Bayes Information Criterion value, Hannan-Quinn Information Criterion value, a Log-likelihood, a Mallows Cp, and an Akaike Information Criterion with small sample correction, all of which are based on known quality techniques for ML models. Other quality criteria for the second trained machine-learning model may be used instead, enabling a broad variety of design options for the proposed concept.

According to an optional embodiment of the method, the measured sampled time-series data may relate to data measured in the context of a computer operating system, stock values, a predictive maintenance service, sales forecasting, warehouse forecasting, traffic development forecasting, or weather forecasting. Additionally, further application areas are clearly possible, making the proposed concept advantageously available to a broad set of industry sectors.

In the context of this description, the following technical conventions, terms and/or expressions may be used:

The term ‘time series’ may denote a series of data points which are indexed in time order. The time-series data may be measured data or predicted data from a machine-learning system.

The term ‘forecasting for time-series data’ may denote that based on the knowledge of historic time-series data a prediction of future values of data points indexed in time is performed, e.g., using a machine-learning system comprising a trained machine-learning model.

The term ‘candidate time lag values’ may denote a sort of delay values by which a first set of time-series data should be displaced against another set of time-series data. A goal for this activity is to find more or less good matching sets of time-series data and a related time lag value.

The term ‘machine-learning system’ may denote a system which is not programmed in a classic, procedural manner but which may adapt its behavior under training conditions if input data and output data are provided (supervised learning process). The input and output data may be denoted as training data. Several feedback mechanisms for adjusting values of weight factors between nodes of different layers of, e.g., a neural network as machine-learning system are known.

The term ‘regularized machine-learning model’ may denote a technique for a development of a machine-learning model of an underlying machine-learning system in order to minimize the adjusted loss function and prevent over fitting or under fitting during training. This may be necessary for large training data sets. The two main types of regularization techniques are Ridge Regularization and LASSO Regularization.

The LASSO approach uses a technique denoted as shrinkage, where data values are shrunk towards the central point, i.e., the mean. The LASSO procedure encourages simple, sparse models with fewer parameters. This particular type of regression works well for models with a high degree of multicollinearity when it makes sense to automate certain parts of a model selection, like variable selection/parameter elimination.

In respect to the regularization, the following additional comments may also support good comprehension: regularization is implemented by adding a “penalty” term to the best fit derived from the trained data to achieve a lesser variance with a tested data and also restricts the influence of a predicate variable over the input variable by compressing its coefficients.

In regularization, one keeps the same number of feature vectors but reduces the magnitude of the related coefficients. Reducing the magnitude of the coefficients can be achieved by using different types of regression techniques that uses regularization to overcome this problem.

The term ‘first training data’ may denote a set of training data for the first of two machine-learning (ML) systems and related machine-learning models used as components of the proposed concept. The first set of training data may be used for the regularized machine-learning model. During this training the number of data points or data pairs of the set of training data may advantageously be reduced. Hence, the process steps after this reduction of training data without a loss of accuracy can be performed with less data, requiring fewer computing resources and/or making subsequent ML model training faster. This way, the original amount or set of first training data may be reduced to a subset of the set of first training data.

The term ‘most influential time lag values’ may denote those time lag values having the highest effect on the ML model under training. The most influential time lag values and the less influential time lag values may be separated by threshold techniques.

Furthermore, in the context of this document ‘long-term lag values’ are lags or lag values that are used to create features (i.e., feature values), while ‘short-term lag values’ are lags or lag values that are used as model parameters. Long-term lags cannot be included directly into the models since a related training would require significant computing power.

The term ‘second training data’ may denote a set of training data appropriate for the training of the second ML system for obtaining a second ML model. In this case, the second ML model is the one adapted for the time-series machine-learning model for predictions.

The term ‘second machine-learning system’ may denote an ML system for a prediction of time-series data using a trained machine learning model. It should also be pointed out that although there is a second ML system, first, second, third and so on, machine learning models may be related to this second machine-learning system. The reason for this is that the ML model for the prediction of the time-series data undergoes several optimization processes to identify the overall best ML model.

The term ‘first time-series machine-learning model’ may denote “the first incarnation” of the ML model for time-series prediction which has been trained using the first machine-learning system.

The term ‘set of second training data’ may denote those training data (i.e., input and output data for supervised learning) used for the training of the second ML system.

The term ‘set of second training data is complete’ may denote a term used in the context of the forward optimization of the ML model of the second machine learning system. Using the Fourier transformation additional data points, i.e., lags/lag values may be identified to support a training of an even better ML model for the forecasting/prediction of the time-series data.

The term ‘first time period’ may denote a time span used for a sampling or measurement of real-world time-series data. In one of the mentioned examples, these data may be workload data taken, e.g., every 10 seconds. The length of the first time period in such an embodiment may typically be in the range of 15 min to about two hours.

The term ‘second time period’ may denote a time span longer than the first time. If the first time period has a length of, e.g., one hour, the second time period/s may end after the second hour, if measured from the beginning of the first time period.

The term ‘p value’ (i.e., probability value) used in this document is also used in the long-standing tradition of probabilistic theories (compare, e.g., R A Fisher Statistical Methods for Research Workers (Oliver and Boyd, Edinburgh, 1926).

Now, a detailed description of the figures follows. All instructions in the figures are schematic. Firstly, a block diagram of an embodiment of the inventive computer-implemented method for time-series forecasting for time-series data with a periodic behavior larger than a respective sampling rate is given. Afterwards, further embodiments, as well as embodiments of the time-series data forecasting system for time-series forecasting for time-series data with a periodic behavior larger than a respective sampling rate will be described.

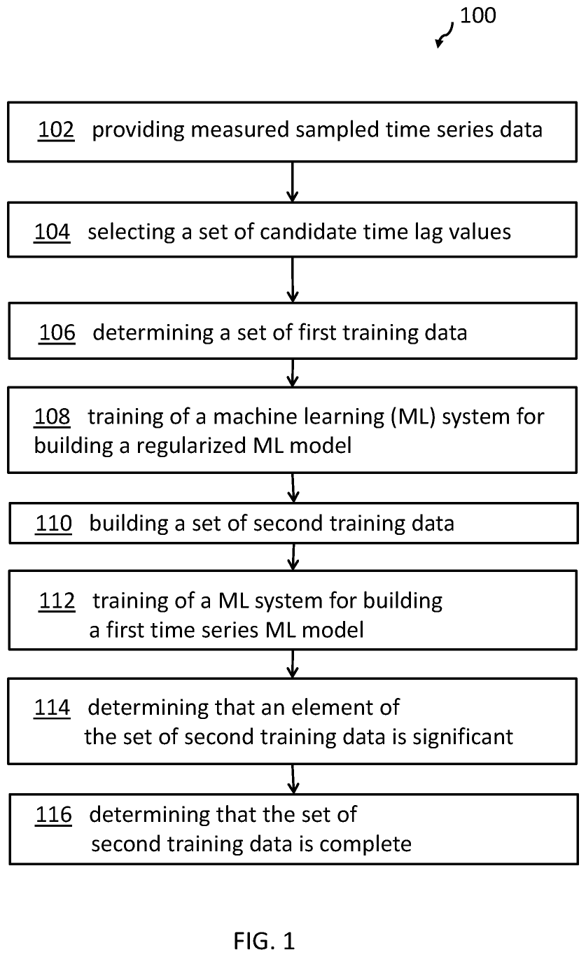

FIG. 1 shows a block diagram of a preferred embodiment of the computer-implemented method for time-series forecasting for time-series data with a periodic behavior larger than a respective sampling rate, typically much larger, e.g., at least 20 times larger, or also 1000 times larger, or more. As an example, the time-series data can originate from a workload management system of a computer system. Here, a typical lag time can be in the range of 10 seconds and a prediction period for the workload can be in the range of about 2 minutes. Other time values are possible. The predicted workload values may be advantageously used for a determination of a start time for a new workload in order to keep the overall workload of the computer system constantly at a value near a theoretical maximum.

The method 100 comprises providing, 102, measured sampled time-series data values, i.e., historic time-series data. The time-series data values are one dimensional, i.e., a scalar value at the sampling time. Alternatively, the proposed concept is also applicable for multi-dimensional time-series data. The method also comprises selecting a set of candidate time lag values. The time at which the sampling of the time-series data happens is usually predefined. It may be based on experience or it may be determined experimentally. It may also depend on the technical field in which the time-series data values have a meaning in “real life”. For the example given above—i.e., the workload management example—sampling frequencies of ‘once every 10 seconds’ is a good starting point. Additionally, selected candidate time lag values may be selected, 104, from the period of a bit more than a week. In other application areas, another scheduling basis may be appropriate.

Additionally, the method 100 comprises determining, 106, a set of first training data based on the measured sampling time-series data and the candidate time lag values. These first training data may also be denoted as feature vectors which may form the source to build a table. More details will be explained in the context of FIG. 2.

Moreover, the method 100 comprises training, 108, of a first machine-learning system for building a regularized machine-learning model using the set of first training data and respective measured sampling time-series data as target data (i.e., ground truth data). As a successfully tested algorithm, the LASSO regression algorithm (e.g., L1 regression=Least Absolute Shrinkage and Selection Operator) is worth to be mentioned. Other regression algorithms are also possible, as mentioned above. Performing the training activity, a subset of the set of the first training data is determined, such that the subset relates to the set of most influential time lag values when training the regularized machine-learning model. Thereby, the data set output by the first feature creation (106) can be reduced in size as a consequence of the characteristics of the LASSO regression training algorithm. Hence, the time lag values having a strong influence on the regularized ML model get a higher weight and “unimportant” time lag values are eliminated. The set of most influential time lag values comprise a set of long-term lag values and a set of short-term lag values. Generally, these two types of time lag values can be separated using a threshold technique.

Furthermore, the method 100 comprises building, 110, a set of second training data based on—i.e., using—the long-term lag values and related measured sampling time-series data. Thereby, the building of the table may be performed, as described above are as in the context of FIG. 2 (i.e., feature creation).

Then, the method 100 comprises training, 112, of a second machine-learning system for building a first time-series machine-learning model. Here, an autoregressive machine-learning technique can be used advantageously for time-series predictions when using measured sampled time-series data as input, wherein the training is using as input (i) the set of second training data, related measured sampled time-series data and the set of short-term lag values. Thereby, a first performance indicator value is indicative of a prediction performance of the first time-series machine-learning model. This may be used to control and manage the training process of the second machine-learning system for generating a second machine-learning model. It may also be mentioned that for the autoregressive ML system also at least the following models can be used: recurrent neural networks (RNN) such as LSTM, or the more general family of Amira learning models.

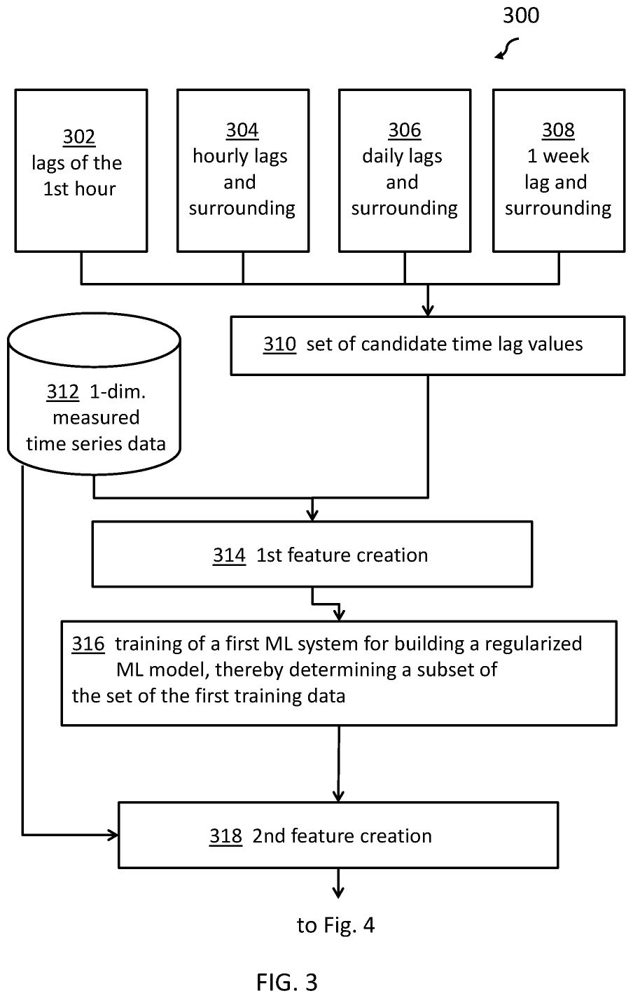

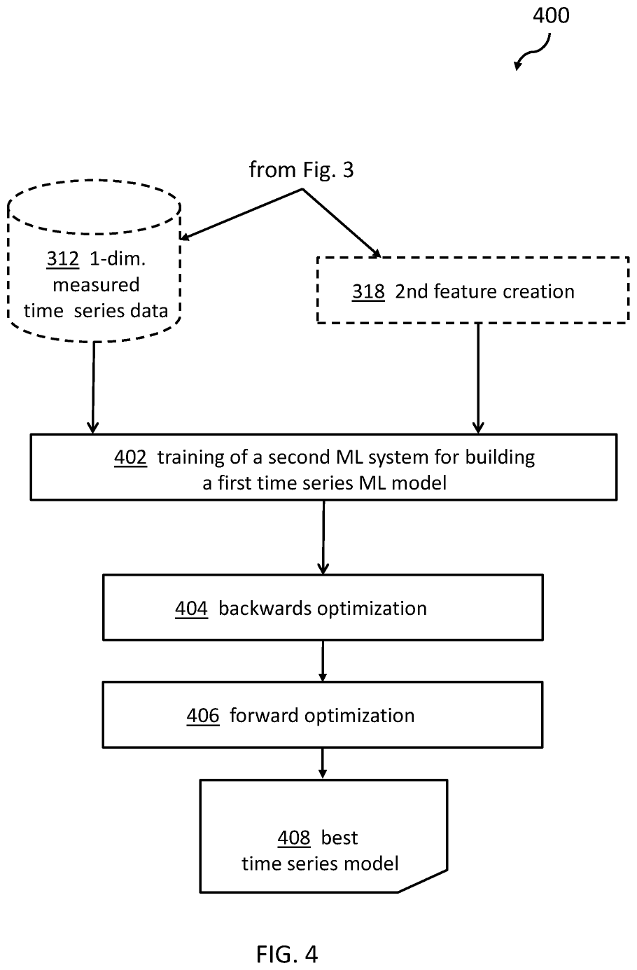

Last but not least, two determination steps are also performed: firstly, backward optimization by determining, 114, that an element—in particular, at least one element—of the set of second training data is significant for the training of the first time-series machine-learning model. If it is not relevant or significant, it can be removed, i.e., the related lag value can be removed from the training data set. Secondly, forward optimization may be performed by determining, 116, that the set of second training data is complete after the determining that an element of the second training data is significant. The terms “backward optimization” and “forward optimization” may also be denoted as backward training and forward training. Both will be explained in more detail in FIGS. 3 and 4.

FIG. 2 shows a diagram 200 of exemplary time-series data 202. This data set 202 represents the first time-series data values which also form the basis for the target 212. Additionally, the displayed time-series data 204 is lacking the value of 2 (i.e., no data values in the first two slots, indicated by “__”). These data are also shown as “time lag 2” data 208. Additionally, time-series data 206 are shown which have the time lag of 4 (i.e., no data values in the first four slots, indicated by “_”). Hence, time lagged value A5 of the first data set 202, time lagged value A3 of the second data set 204 and time lagged value A1 of the third data set 206 are related to each other. Another interpretation is that starting from (i.e., input value) time lag value A3 or A1 a prediction (e.g., for the workload) in the next time interval should have a value close to A5. This can also be clearly understood using the table of the time-series data set 208 (e.g., first feature vector), the time-series data set 210 (e.g., second feature vector) and the target vector 212.

It should also be mentioned, that a time lags of 2 out of 4 are only examples. The actual time lag data in real applications can be much larger.

FIG. 3 shows a first part of a block diagram of a more implementation-near embodiment 300 of the proposed concept. Firstly, a set of candidate time lag values needs to be determined, 310. For that, as an example, the sampled time lag values 302 of the first hour, hourly time lag values 304 at the end of each full hour and a couple of values 306 before and after, daily time lag values and a couple of values before and after (i.e., from the surrounding), as well as time lag data values 308 at the end of an entire week and a couple of values before and after may built the basis for the set of candidate time lag values 310.

Based on this, first feature vectors are created, 314, based on the set of candidate time lag values 310 as well as the one-dimensional measured time-series data 312. This creation 314 of the features vector is done, as explained in the context of FIG. 2, the feature vector table and the target (FIG. 2, 212).

The resulting data are then used for a training 316 of a first ML system for building a regularized model—exemplary described above as LASSO model—through which a subset of the set of first training data are also determined as the valuable output of this method step.

The so determined subset of the first training data comprises long-term lag values and a set of short-term lag values. For the next step, i.e., the second feature creation 318, only the long-term lag values are used. The flowchart to be continued with a description of FIG. 4.

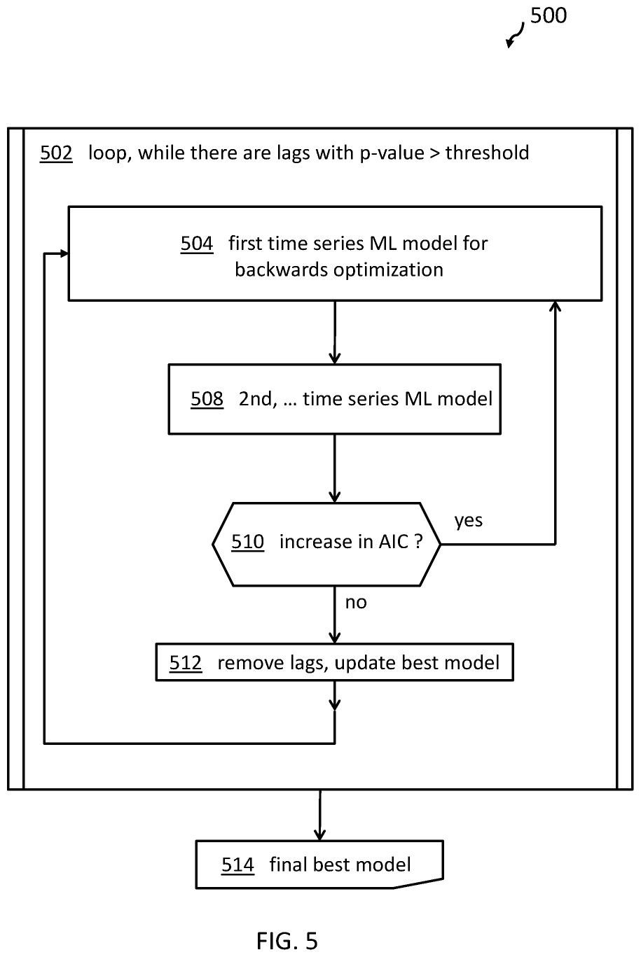

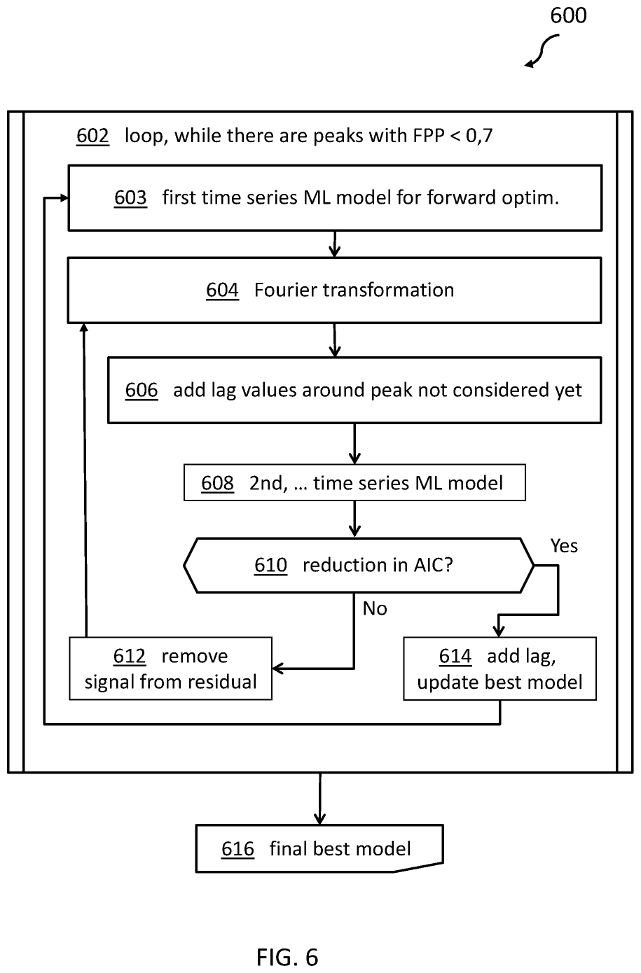

FIG. 4 shows a second part 400 of the block diagram of the more implementation-near embodiment of FIG. 3. FIG. 4 shows again the block diagram elements 312 and 318 (observe the dashed lines). Both data sources are used for a training 402 of a second ML system for building a first time-series ML model. This first time-series ML model may undergo a series of iterations during the steps of the backward optimization 404 (to be detailed in the context of FIG. 5) and the forward optimization 406 (to be detailed in the context of FIG. 6). Such iteration finally results in the best time-series model 408. It should also be noted that the backward optimization 404 as well as the forward optimization 406 are each executed in loops which involve a retraining of the second ML system for building additional time-series ML models.

FIG. 5 shows a block diagram of the applied backward training 500 of the proposed concept. This diagram shows exemplary details of the step 114 “determining that an element of the set of second training data is significant . . . ”. Basically, a loop process 502 is detailed in order to determine a final best model 514 for the backward optimization.

As starting point, the first time-series ML model 504 is trained in step 112 (“training of a machine learning system for building a first time-series ML model . . . ”) is used as a basis. In the beginning, a threshold value for p-values is defined. Also, after the training of the autoregressive model each feature vector related to the target vector is assigned a p-value. It represents an indicator (e.g., probability) for predicting the target vector components starting with the related feature vector (compare FIG. 2, 212).

This way, the feature vectors can be sorted in an ascending or descending order for a deselection of, e.g., the 10 worst feature vectors with p-values larger than the predefined threshold value after the training 508 of the second ML training, i.e., the training for the time-series model.

If now an exclusion of one or more of the 10 worst feature vectors with p-values larger than the predefined threshold value shows an increase in the model quality 510 (i.e., a decrease in the AIC value) in the loop of a re-trained autoregressive ML model and retrained time-series ML model, resulting in the second time-series ML model 508, the related time lag feature vectors are removed, 512, from the training set for the training of the second machine learning model. At the same time, the best second ML model for a prediction of time-series data is updated defining an updated best model. If an exclusion does not result in an increase in the model quality, then the process continues with a loop back to 502 for the next [set of] feature vectors. If such loop process has been performed with all existing feature vectors—or a predefined number thereof—the updated best model becomes the final best model 514 for the backward optimization process.

FIG. 6 shows a block diagram 600 of the applied forward training or forward optimization of the proposed concept. This process is in some aspects similar to the partial process, described in the context of FIG. 5. However, here a Fourier transformation 604 is used in the loop 602 which should be run as long as there are FFPs<a predefined value, e.g., 0.7 (stop condition). FPP stands here for “False Positive Probability” of an observed peak in the Fourier transformation occurring due to random data. As a starting point—i.e., first time-series ML model 603 for forward optimization—the updated best model from the backward optimization (compare FIG. 5) is used. From this, residuals—i.e., a difference between predicted time-series data and related target vector values—are used as input for the Fourier transformation 604.

Typically, results of the Fourier transformation 604 show some peaks in the amplitudes of certain frequencies. The frequencies are used to identify time lag values. The related time lag value as well as some lag values before and after are used as additional training data—compare “add lag values . . . ”, 606 in FIG. 6—for a training of the second machine learning system for building the autoregressive ML model, 608. Again, a quality indicator—e.g., AIC or others—for the accuracy of the prediction of the related ML model is used. If the additional training data show no reduction in the AIC value (610 case “no”), the lag values relating to the residuals are removed, 612, again.

If a reduction in the AIC value of the time series model is observed in the determination 610, the related time lag feature vector is added to the set of training data to build the second ML model for the time-series prediction. Then, the formerly best ML model for time-series prediction is updated, 614, by a retraining with a new and extended training data set, and the loop 602 continues until the stop condition is satisfied. Now, the final best model 616 has been determined.

In case there is no reduction in the AIC value in the determination 610 when two subsequent loop steps are compared, the respective signal is removed, 612, from the residual and the process returns to the Fourier transformation step 604 of the loop 602.

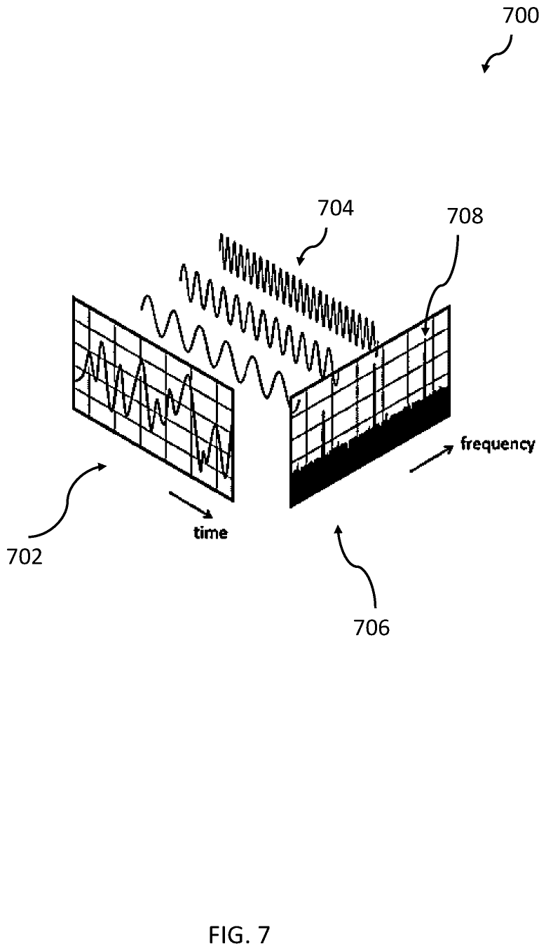

FIG. 7 shows an illustration 700 of a Fourier transformation as used in an embodiment of the proposed concept. Projection 702 shows the input signal before the Fourier transformation, whereas the individual frequencies 704 (only three are shown for comprehensibility reasons) show the transformed signal. The different frequencies 704 have different signal strength. The projection 706 of the frequencies can show certain peak values such as peak values 708. This may be measured against the average of the remaining frequency amplitude values. If one or a couple of the resulting frequencies show amplitude values above a certain threshold value, the peak frequencies are interpreted as special time lag values and used as explained in the context of FIG. 6.

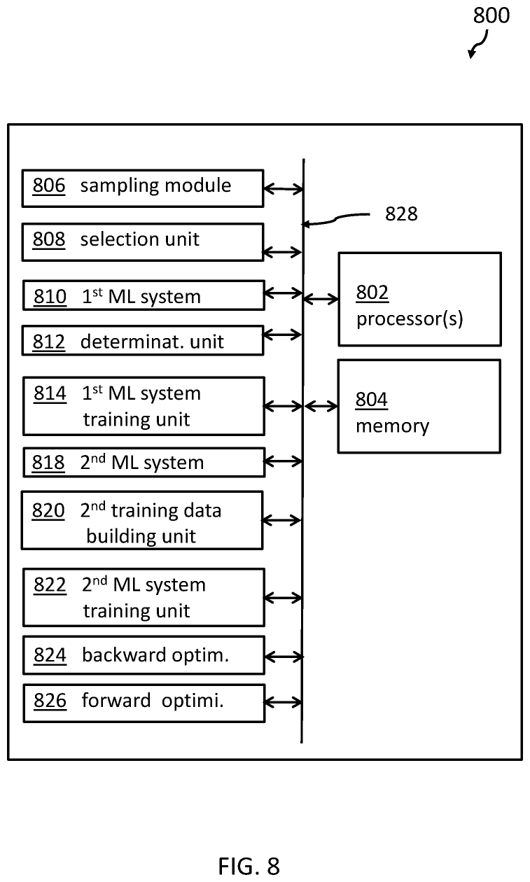

FIG. 8 shows a block diagram of an embodiment of the time-series data forecasting system 800 for time-series forecasting for time-series data with a periodic behavior larger than a respective sampling rate. The system comprises one or more processors 802 and a memory 804 operatively coupled to the one or more processors 802, wherein the memory 804 stores program code portions which, when executed by the one or more processors 802, enable the one or more processors 802 to provide-in particular, using a sampling module 806—measured sampled time-series data, to select-in particular, using a selection unit 808—a set of candidate time lag values, and determine-in particular, using a first determination unit 810—a set of first training data based on the measured sampling time-series data and the candidate time lag values.

Furthermore, the one or more processors 802 are also enabled to train of a first machine-learning system 810—in particular, using a first ML training unit 814—for building a regularized machine-learning model, using the set of first training data and respective measured sampling time-series data as target data. Thereby, a subset of the set of the first training data is determined, were a subset relates to a set of most influential time lag values when training the regularized machine-learning. Furthermore, the set of most influential time lag values comprises a set of long-term lag values and a set of short-term lag values.

Additionally, the one or more processors 802 are also enabled to build a set of second training data—in particular, using a second training data building module 820—based on the long-term lag values and related measured sampling time-series data, and to train of a second machine-learning system 818—in particular, using a second ML training unit 822—for building a first time-series machine-learning model for time-series predictions when using measured sampled time-series data as input. Thereby, the training is using as input the set of second training data, related measured sampled time-series data and the set of short-term lag values. Furthermore, a first performance indicator value is indicative of a prediction performance of the first time-series machine-learning model.

In addition, the one or more processors 802 are enabled to determine—in particular, backward optimizer 824—that an element of the set of second training data is significant for the training of the first time-series machine-learning model, and to determine, after the determining that an element of the second training data is significant—in particular, the forward optimizer 826—that the set of second training data is complete.

It shall also be mentioned that all functional units, modules and functional blocks may be communicatively coupled to each other for signal or message exchange in a selected 1:1 manner. Alternatively, the functional units, modules and functional blocks can be linked to a system internal bus system 828 for a selective signal or message exchange. As functional units, modules and functional blocks at least the following are considered: the one or more processors 802, the memory 804, the sampling module 806, the selection unit 808, the 1^{st} ML system 810, the determination unit 812, the 1^{st} ML system training unit 814, the 2^{nd} ML system 818, the 2^{nd} training data building unit 820, the second ML system training unit 822, the backward optimizer 824 and the forward optimizer 826.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

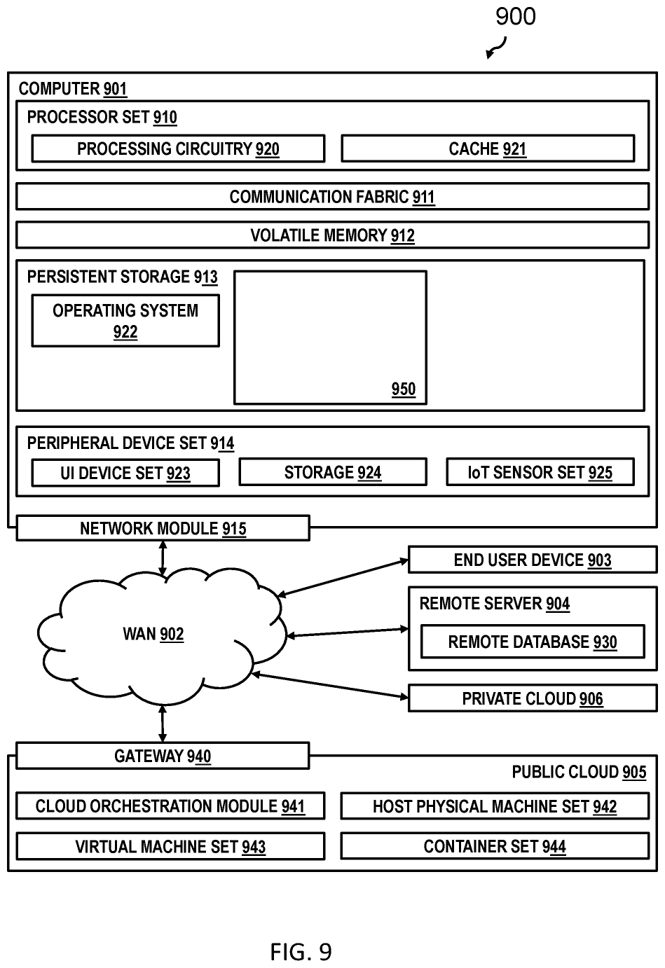

FIG. 9 shows a computing environment 900 comprising an example of an environment for the execution of at least some of the computer code 950 involved in performing the inventive methods, such as the computer-implemented method 100 for time-series forecasting for time-series data with a periodic behavior larger than a respective sampling rate.

In addition to block 950, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 950 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (e.g., secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (e.g., embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

It should also be mentioned that the time-series data forecasting system 800 for time-series forecasting for time-series data with a periodic behavior larger than a respective sampling rate can be an operational sub-system of the computer 901 and may be attached to a computer-internal bus system.

The terminology used herein is for the purpose of describing particular embodiments only and is not intended to limit the invention. As used herein, the singular forms a, an and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

In a nutshell, the inventive concept can be summarized by the following clauses:
1. A computer-implemented method for time-series forecasting for time-series data with a periodic behavior larger than a respective sampling rate, the method comprising
   providing measured sampled time-series data,
   selecting a set of candidate time lag values,
   determining a set of first training data based on the measured sampling time-series data and the candidate time lag values,
   training of a first machine-learning system for building a regularized machine-learning model, using the set of first training data and respective measured sampling time-series data as target data, thereby determining a subset of the set of the first training data, the subset relating to a set of most influential time lag values when training the regularized machine-learning model,
wherein the set of most influential time lag values comprises a set of long-term lag values and a set of short-term lag values,
   building a set of second training data based on the long-term lag values and related measured sampling time-series data,
   training of a second machine-learning system for building a first time-series machine-learning model for time-series predictions when using measured sampled time-series data as input,
wherein the training is using as input:
the set of second training data, related measured sampled time-series data and the set of short-term lag values,
wherein a first performance indicator value is indicative of a prediction performance of the first time-series machine-learning model,
   determining that an element of the set of second training data is significant for the training of the first time-series machine-learning model, and
   determining, after the determining that an element of the second training data is significant, that the set of second training data is complete.
2. The method according to clause 1, wherein the selecting the candidate time lag values comprises
   candidate time lag values from a first time period, and
   candidate time lag values at a plurality of second time periods.
3. The method according to clause 1 or 2, wherein the determining the set of first training data comprises
   building a table, wherein components of table dimensions comprise elements of the measured sampled time-series data respectively shifted by selected candidate time lag values.

4. The method according to any of the preceding clauses, wherein the regularized machine-learning model is selected out of the group comprising a Least Absolute Shrinkage and Selection Operator regression algorithm, a Ridge regression algorithm an Elastic Net regression algorithm, a tree-based machine-learning model.
5. The method according to any of the preceding clauses, wherein the determining that an element of the second training data is significant for the training of the first time-series machine-learning model comprises
   deselecting an element of the second training if its exclusion results in a smaller or equal second performance indicator value if compared to the first performance indicator value, wherein the second performance indicator value is indicative of a prediction performance of the second time-series machine-learning model, wherein the second time-series machine-learning model is trained in the same way as the first time-series machine-learning model but without the deselected element of the second training data.
6. The method according to any of the preceding clauses, wherein the determining that the set second training data is complete comprises
performing a Fourier transformation of an error signal, wherein the error signal is a difference signal between ground truth time-series data and predicted time-series data of the first time-series machine-learning model.
7. The method according to clause 6, also comprising
   adding candidate time lags surrounding a frequency of a peak value in an amplitude of the Fourier transformation, wherein the frequencies determined as a result of the of the Fourier transformation are interpreted as time lag values.
8. The method according to clause 7, wherein the peak frequency value is a plurality of a predefined number of peak frequency values of the Fourier transformation.
9. The method according to any of the preceding clauses, wherein the first performance indicator, the second performance indicator and the third performance indicator is selected out of the group consisting of a mean squared error, a root mean squared error, an Akaike information criterion value, a Bayes Information Criterion, Hannan-Quinn Information Criterion, a Log-likelihood, a Mallows Cp, and an Akaike Information Criterion with small sample correction.
10. The method according to any of the preceding clauses, wherein the measured sampled time-series data are related to data measured in the context of a computer operating system, stock values, a predictive maintenance service, sales forecasting, warehouse forecasting, traffic development, or weather forecasting.
11. A time-series data forecasting system for time-series forecasting for time-series data with a periodic behavior larger than a respective sampling rate, the system comprising
   one or more processors and a memory operatively coupled to the one or more processors, wherein the memory stores program code portions which, when executed by the one or more processors, enable the one or more processors to
   provide measured sampled time-series data,
   select a set of candidate time lag values,
   determine a set of first training data based on the measured sampling time-series data and the candidate time lag values,
   train of a first machine-learning system for building a regularized machine-learning model, using the set of first training data and respective measured sampling time-series data as target data, thereby determining a subset of the set of the first training data, the subset relating to a set of most influential time lag values when training the regularized machine-learning model, wherein the set of most influential time lag values comprises a set of long-term lag values and a set of short-term lag values,
   build a set of second training data based on the long-term lag values and related measured sampling time-series data,
   train of a second machine-learning system for building a first time-series machine-learning model for time-series predictions when using measured sampled time-series data as input, wherein the training is using as input:
the set of second training data, related measured sampled time-series data and the set of short-term lag values,
wherein a first performance indicator value is indicative of a prediction performance of the first time-series machine-learning model,
   determine that an element of the set of second training data is significant for the training of the first time-series machine-learning model, and
   determine, after the determining that an element of the second training data is significant, that the set of second training data is complete.
12. The system according to clause 11, wherein the selecting the candidate time lag values comprises
candidate time lag values from a first time period,
candidate time lag values at a plurality of second time periods.
13. The system according to clause 11 or 12, wherein the determining the set of first training data comprises
   building a table, wherein components of table dimensions comprise elements of the measured sampled time-series data respectively shifted by selected candidate time lag values.
14. The system according to any of the clauses 11 to 13, wherein the regularized machine-learning model is selected out of the group comprising: a Least Absolute Shrinkage and Selection Operator regression algorithm, a Ridge regression algorithm an Elastic Net regression algorithm, a tree-based machine-learning model.
15. The system according to any of the clauses 11 to 14, wherein the determining that an elements of the second training data are significant for the training of the first time-series machine-learning model comprises
   deselecting an element of the second training if its exclusion results in a smaller or equal second performance indicator value if compared to the first performance indicator value,
      wherein the second performance indicator value is indicative of a prediction performance of the second time-series machine-learning model,
      wherein the second time-series machine-learning model is trained in the same way as the first time-series machine-learning model but without the deselected element of the second training data.
16. The system according to any of the clauses 11 to 15, wherein the determining that the set second training data is complete comprises
   performing a Fourier transformation of an error signal, wherein the error signal is a difference signal between ground truth time-series data and predicted time-series data of the first time-series machine-learning model.
17. The system according to clause 16, also comprising
   adding candidate time lags surrounding a frequency of a peak value in an amplitude of the Fourier transformation, wherein the frequencies determined as a result of the of the Fourier transformation are interpreted as time lag values.
18. The system according to clause 17, wherein the first performance indicator, the second performance indicator and the third performance indicator is selected out of the group consisting of a mean squared error, a root mean squared error, an Akaike information criterion value, a Bayes Information Criterion, Hannan-Quinn Information Criterion, a Log-likelihood, a Mallows Cp, and an Akaike Information Criterion with small sample corrections.
19. The system according to any of the clauses 11 to 13, wherein the measured sampled time-series data are related to data measured in the context of a computer operating system, stock values, a predictive maintenance service, sales forecasting, warehouse forecasting, traffic development, or weather forecasting.
20. A computer program product for time-series forecasting for time-series data with a periodic behavior larger than a respective sampling rate, the computer program product comprising a computer readable storage medium having program instructions embodied therewith, the program instructions being executable by one or more computing systems or controllers to cause the one or more computing systems to
   provide measured sampled time-series data,
   select a set of candidate time lag values,
   determine a set of first training data based on the measured sampling time-series data and the candidate time lag values;
   train of a first machine-learning system for building a regularized machine-learning model, using the set of first training data and respective measured sampling time-series data as target data, thereby determining a subset of the set of the first training data, the subset relating to a set of most influential time lag values when training the regularized machine-learning model, wherein the set of most influential time lag values comprises a set of long-term lag values and a set of short-term lag values,
   build a set of second training data based on the long-term lag values and related measured sampling time-series data,
   train of a second machine-learning system for building a first time-series machine-learning model for time-series predictions when using measured sampled time-series data as input,
wherein the training is using as input:
the set of second training data, related measured sampled time-series data and the set of short-term lag values,
wherein a first performance indicator value is indicative of a prediction performance of the first time-series machine-learning model,
   determine that an element of the set of second training data is significant for the training of the first time-series machine-learning model, and
   determine, after the determining that an element of the second training data is significant, that the set of second training data is complete.

What is claimed is:

1. A computer-implemented method for time-series forecasting for time-series data with a periodic behavior larger than a respective sampling rate, the method comprising:
providing measured sampled time-series data;
selecting a set of candidate time lag values;
determining a set of first training data based on the measured sampled time-series data and the candidate time lag values;
training of a first machine-learning system for building a regularized machine-learning model, using the set of first training data and respective measured sampling time-series data as target data, thereby determining a subset of the set of first training data, the subset relating to a set of most influential time lag values when training the regularized machine-learning model, wherein the set of most influential time lag values comprises a set of long-term lag values and a set of short-term lag values;
building a set of second training data based on the set of long-term lag values and related measured sampling time-series data;
training of a second machine-learning system for building a first time-series machine-learning model for time-series predictions when using measured sampled time-series data as input, wherein the training is using as input the set of second training data, related measured sampled time-series data and the set of short-term lag values, wherein a first performance indicator value is indicative of a prediction performance of the first time-series machine-learning model;
determining that an element of the set of second training data is significant for training of the first time-series machine-learning model; and
determining, after the determining that an element of the second training data is significant, that the set of second training data is complete.

2. The method of claim 1, wherein the set of candidate time lag values comprises candidate time lag values from a first time period and candidate time lag values at a plurality of second time periods.

3. The method of claim 1, wherein determining the set of first training data comprises building a table, wherein components of table dimensions comprise elements of the measured sampled time-series data respectively shifted by selected candidate time lag values.

4. The method of claim 1, wherein the regularized machine-learning model is selected from the group consisting of a Least Absolute Shrinkage and Selection Operator regression algorithm, a Ridge regression algorithm an Elastic Net regression algorithm, and a tree-based machine-learning model.

5. The method of claim 1, wherein determining that an element of the set of second training data is significant for training the first time-series machine-learning model comprises deselecting an element of the set of second training data if its exclusion results in a smaller or equal second performance indicator value if compared to the first performance indicator value, and wherein the second performance indicator value is indicative of a prediction performance of a second time-series machine-learning model, and wherein the second time-series machine-learning model is trained in a same way as the first time-series machine-learning model but without the deselected element of the set of second training data.

6. The method of claim 1, wherein determining that the set of second training data is complete comprises performing a Fourier transformation of an error signal, wherein the error signal is a difference signal between ground truth time-series data and predicted time-series data of the first time-series machine-learning model.

7. The method of claim 6, further comprising:
adding candidate time lags surrounding a frequency of a peak value in an amplitude of the Fourier transformation, wherein frequencies determined as a result of the Fourier transformation are interpreted as time lag values.

8. The method of claim 7, wherein the peak value is a plurality of a predefined number of peak frequency values of the Fourier transformation.

9. The method of claim 1, wherein the first performance indicator, a second performance indicator and a third performance indicator are selected from the group consisting of a mean squared error, a root mean squared error, an Akaike information criterion value, a Bayes Information Criterion, Hannan-Quinn Information Criterion, a Log-likelihood, a Mallows Cp, and an Akaike Information Criterion with small sample correction.

10. The method of claim 1, wherein the measured sampled time-series data are related to data measured in a context of a computer operating system, stock values, a predictive maintenance service, sales forecasting, warehouse forecasting, traffic development, or weather forecasting.

11. A time-series data forecasting system for time-series forecasting for time-series data with a periodic behavior larger than a respective sampling rate, the system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
providing measured sampled time-series data;
selecting a set of candidate time lag values;
determining a set of first training data based on the measured sampled time-series data and the candidate time lag values;
training of a first machine-learning system for building a regularized machine-learning model, using the set of first training data and respective measured sampling time-series data as target data, thereby determining a subset of the set of first training data, the subset relating to a set of most influential time lag values when training the regularized machine-learning model, wherein the set of most influential time lag values comprises a set of long-term lag values and a set of short-term lag values;
building a set of second training data based on the set of long-term lag values and related measured sampling time-series data;
training of a second machine-learning system for building a first time-series machine-learning model for time-series predictions when using measured sampled time-series data as input, wherein the training is using as input the set of second training data, related measured sampled time-series data and the set of short-term lag values, wherein a first performance indicator value is indicative of a prediction performance of the first time-series machine-learning model;
determining that an element of the set of second training data is significant for training of the first time-series machine-learning model; and
determining, after the determining that an element of the second training data is significant, that the set of second training data is complete.

12. The system of claim 11, wherein the set of candidate time lag values comprises candidate time lag values from a first time period and candidate time lag values at a plurality of second time periods.

13. The system of claim 11, wherein determining the set of first training data comprises building a table, wherein components of table dimensions comprise elements of the measured sampled time-series data respectively shifted by selected candidate time lag values.

14. The system of claim 11, wherein the regularized machine-learning model is selected from the group consisting of a Least Absolute Shrinkage and Selection Operator regression algorithm, a Ridge regression algorithm an Elastic Net regression algorithm, and a tree-based machine-learning model.

15. The system of claim 11, wherein determining that an element of the set of second training data is significant for training the first time-series machine-learning model comprises deselecting an element of the set of second training data if its exclusion results in a smaller or equal second performance indicator value if compared to the first performance indicator value, and wherein the second performance indicator value is indicative of a prediction performance of a second time-series machine-learning model, and wherein the second time-series machine-learning model is trained in a same way as the first time-series machine-learning model but without the deselected element of the set of second training data.

16. The system according to claim 11, wherein determining that the set of second training data is complete comprises performing a Fourier transformation of an error signal, wherein the error signal is a difference signal between ground truth time-series data and predicted time-series data of the first time-series machine-learning model.

17. The system of claim 16, further comprising:
adding candidate time lags surrounding a frequency of a peak value in an amplitude of the Fourier transformation, wherein frequencies determined as a result of the Fourier transformation are interpreted as time lag values.

18. The system of claim 11, wherein the first performance indicator, a second performance indicator and a third performance indicator are selected from the group consisting of a mean squared error, a root mean squared error, an Akaike information criterion value, a Bayes Information Criterion, Hannan-Quinn Information Criterion, a Log-likelihood, a Mallows Cp, and an Akaike Information Criterion with small sample correction.

19. The system according to claim 11, wherein the measured sampled time-series data are related to data measured in a context of a computer operating system, stock values, a predictive maintenance service, sales forecasting, warehouse forecasting, traffic development, or weather forecasting.

20. A computer program product for time-series forecasting for time-series data with a periodic behavior larger than a respective sampling rate, the computer program product comprising:
one or more computer-readable tangible storage medium and program instructions stored on at least one of the one or more tangible storage medium, the program instructions executable by a processor capable of performing a method, the method comprising:
providing measured sampled time-series data;
selecting a set of candidate time lag values;
determining a set of first training data based on the measured sampled time-series data and the candidate time lag values;
training of a first machine-learning system for building a regularized machine-learning model, using the set of first training data and respective measured sampling time-series data as target data, thereby determining a subset of the set of first training data, the subset relating to a set of most influential time lag values when training the regularized machine-learning model, wherein the set of most influential time lag values comprises a set of long-term lag values and a set of short-term lag values;
building a set of second training data based on the set of long-term lag values and related measured sampling time-series data;
training of a second machine-learning system for building a first time-series machine-learning model for time-series predictions when using measured sampled time-series data as input, wherein the training is using as input the set of second training data, related measured sampled time-series data and the set of short-term lag values, wherein a first performance indicator value is indicative of a prediction performance of the first time-series machine-learning model;
determining that an element of the set of second training data is significant for training of the first time-series machine-learning model; and
determining, after the determining that an element of the second training data is significant, that the set of second training data is complete.
